(19) United States
(12) Patent Application Publication
(10) Pub. No.: US 2010/0161369 A1
(43) Pub. Date: Jun. 24, 2010

(54) APPLICATION OF RELATIONSHIP WEIGHTS TO SOCIAL NETWORK CONNECTIONS

(75) Inventors: Stephen Paul FARRELL, San Francisco, CA (US); Ido GUY, Haifa (IL); Noga MESHULAM, Timrat (IL); Inbal RONEN, Haifa (IL); Elad SHAHAR, Rehovot (IL); Sigalit UR, D.N. Misgav (IL); Eric WILCOX, Los Altos, CA (US)

Correspondence Address: Patents On Demand, P.A.-IBM SVL, 4581 Weston Road, Suite 345, Weston, FL, 33331, US

(73) Assignee: INTERNATIONAL BUSINESS MACHINES CORPORATION, Armonk, NY (US)

(21) Appl. No.: 12/342,409

(22) Filed: Dec. 23, 2008

(51) Int. Cl. G06F 17/30; G05B 19/418; G06F 9/46

(52) U.S. Cl. 705/8; 707/E17.009; 707/E17.044

(57) ABSTRACT

A method and system for relationship weighting in social networks are provided. The method includes identifying a plurality of sources of relationship data and extracting from each source a list of connected contacts with a relationship strength for each connection. The lists of contacts from the sources are aggregated into an aggregated list, with each source having a source weighting. The aggregated list is applied to an un-weighted social network to provide relationship strengths between contacts.

### FIELD OF THE INVENTION

This invention relates to the field of social networks. In particular, the invention relates to application of relationship weights to social network connections.

### BACKGROUND OF THE INVENTION

Social software—software that has people as its focal point—takes many different forms. From blogs and wikis through recommender systems to social bookmarking and personal network systems—social applications proliferate. In continuation to its dominance on the internet, social software has recently emerged in organizations, as a mean of connecting employees in a better way and enhancing knowledge management and expertise location.

Potential sources of social information are very diverse. Different users make use of different tools, and social information is scattered among many services and applications. As these applications rarely interoperate, each is typically only aware of its own social data and cannot benefit from other applications' data.

A social network service (SNS) focuses on building online communities of people who share interests and activities, or who are interested in exploring the interests and activities of others. Most social network services are web based and provide a variety of ways for users to interact, such as e-mail and instant messaging services. Social networking has created powerful new ways to communicate and share information. The main types of social networking services are those which contain directories of some categories (such as former classmates), means to connect with friends (usually with self-description pages), and recommender systems linked to trust.

Social network services, like Facebook (Facebook is a trade mark of Facebook, Inc.) and LinkedIn (LinkedIn is a trade mark of LinkedIn Corporation) hold a social network defined by reciprocal acknowledgement of both sides of each relationship. In other words, a connection (or edge) in these networks is usually defined by one side inviting the other side to connect and the other side accepting the invitation. A few SNSs allow one-sided definition of the social network, and skip the acceptance or confirmation stage (one example is an organizational SNS in IBM called Beehive (IBM and Beehive are trade marks of International Business Machines Corporation)).

Each person in a SNS has a list of people who are his “connections”. Sometimes these connections are categorized, e.g. colleagues, neighbors, etc or sorted by how recently the connection was established, or sorted alphabetically. In some SNSs, like in Facebook, there is a way to define the top t friends and the bottom b friends, when t and b are fixed numbers set in advance by the system.

### SUMMARY OF THE INVENTION

According to a first aspect of the present invention there is provided a method for relationship weighting in social networks, comprising: identifying a plurality of sources of relationship data; extracting from each source a list of connected contacts with a relationship strength for each connection; aggregating the lists of contacts from the sources into an aggregated list, with each source having a source weighting; and applying the aggregated list to a social network to provide relationship strengths between contacts.

The list of connected contacts extracted from each source may be a list of connected contacts to an identified contact and applying the aggregated list may provide relationship strengths between contacts and the identified contact.

Each source may define relationship strengths for each connection according to relationship strength measures. As examples, the relationship strength measures may include one or more of the group of: number of common interactions between contacts, number of total interactions of each contact, number of participant contacts in each interaction, time span of interaction, symmetry of interaction, reciprocity of interaction, sentiment of interaction, density of interaction, age of interaction.

The source weightings may be user configurable.

Applying the aggregated list to a social network may apply the aggregated list to a social network with no previously defined relationship strengths.

Sources of relationship data may include public sources of contact connections. Examples of public sources of contact connections may include one or more of the group including: web logs (blogs), wikis, friending applications, social tagging networks, social network services, publication or patent repositories, organizational charts, forums, file and photo sharing sites, and web communities.

Sources of relationship data may include private sources of contact connections and wherein access to the derived data is restricted to the owners of the private sources. Examples of the private sources of contact connections may include one or more of the group including: email applications, instant messaging applications, calendar and scheduling applications.

The method may include providing evidence of the derivation of contacts relationship strengths. The evidence may be in the form of time-ordered log entries from the sources.

In one embodiment, applying the aggregated list to a social network to provide relationship strengths between contacts provides a contact list for an instant messaging system based on the relationship strength to the instant messaging application user. A preview of the contact list may be provided with different user selection of the source weightings.

In another embodiment, the method may include integrating the method with a topic search to locate contacts with expertise on the topic.

In a further embodiment, applying the aggregated list to a social network to provide relationship strengths between contacts provides automatic completion of names.

In a yet further embodiment, applying the aggregated list to a social network to provide relationship strengths between contacts provides social paths for indirectly related contacts.

In a yet further embodiment, applying the aggregated list to a social network to provide relationship strengths between contacts provides enhanced social network services.

According to a second aspect of the present invention there is provided a computer software product for relationship weighting in social networks, the product comprising a computer-readable storage medium, storing a computer in which program comprising computer-executable instructions are stored, which instructions, when read executed by a computer, perform the following steps: identifying a plurality of sources of relationship data; extracting from each source a list of connected contacts with a relationship strength for each connection; aggregating the lists of contacts from the sources into an aggregated list, with each source having a source weighting; and applying the aggregated list to a social network to provide relationship strengths between contacts.

According to a third aspect of the present invention there is provided a method of providing a service to a customer over a network, the service comprising: identifying a plurality of sources of relationship data; extracting from each source a list of connected contacts with a relationship strength for each connection; aggregating the lists of contacts from the sources into an aggregated list, with each source having a source weighting; and applying the aggregated list to a social network to provide relationship strengths between contacts.

According to a fourth aspect of the present invention there is provided a system for relationship weighting in social networks, comprising: a processor; means for connection to a plurality of sources of relationship data; means for extracting from each source a list of connected contacts with a relationship strength for each connection; means for aggregating the lists of contacts from the sources into an aggregated list, with each source having a source weighting; and means for applying the aggregated list to a social network to provide relationship strengths between contacts.

The system may include means for input of user configurable source weightings.

The sources of relationship data may include private sources of contact connections and the system may include means to restrict access to the derived data to the owners of the private sources.

The system may include means for providing evidence of the derivation of contacts relationship strengths.

### BRIEF DESCRIPTION OF THE DRAWINGS

The subject matter regarded as the invention is particularly pointed out and distinctly claimed in the concluding portion of the specification. The invention, both as to organization and method of operation, together with objects, features, and advantages thereof, may best be understood by reference to the following detailed description when read with the accompanying drawings in which:

FIG. 1 is a schematic diagram of sources of contact information in a social network architecture in accordance with the present invention;

FIG. 2 is a flow diagram of a method in accordance with the present invention;

FIG. 3 is a block diagram of a system in accordance with the present invention;

FIGS. 4A to 4D are diagrams showing graphical user interfaces of an embodiment of the present invention;

FIG. 5 is a diagram showing a graphical user interface of a friending application in a further embodiment of the present invention; and

FIG. 6 is a block diagram of a computer system in which the present invention may be implemented.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

A method and system are described which enable information to be gathered from different social network sources relating to the strength of relationships between contacts. The gathered information is aggregated with weightings being given to different sources. The aggregated relationship strengths can be used to weight the results of social networks which are not weighted themselves.

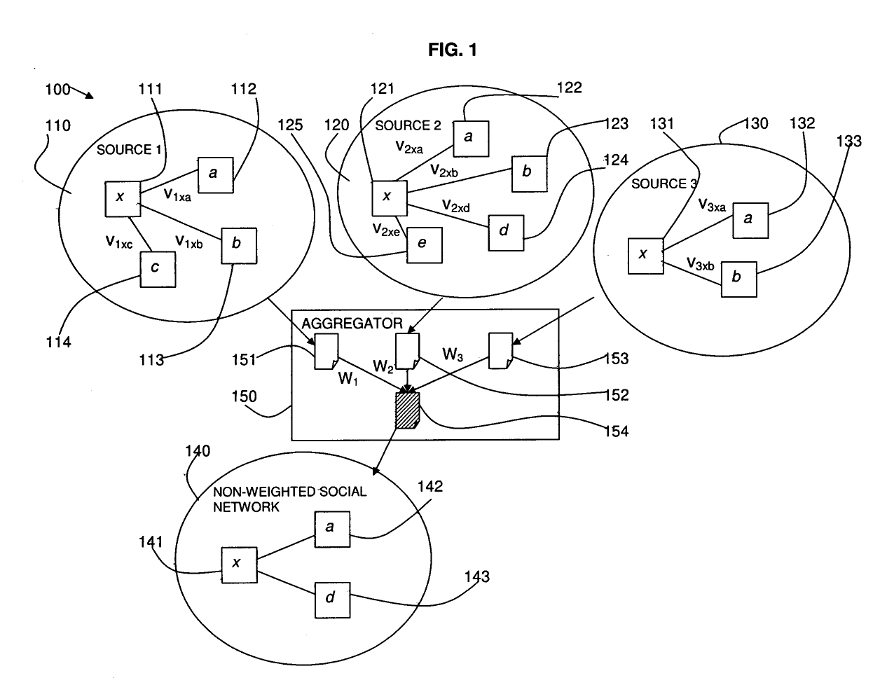

Referring to FIG. 1, a schematic diagram 100 shows three sources 110-130 of social network data. For example, the sources 110-130 may be any social network data source that can provide information about how strongly people are connected and, optionally, by what means. Such sources 110-130 may include, for example: blogs (web logs); wikis (collections of web pages designed to enable anyone who accesses it to contribute or modify content); friending applications; social tagging networks; social network services; email applications; instant messaging applications; calendar and scheduling applications; publication or patent repositories; and organizational charts.

The sources 110-130 have contacts with connections to other contacts. In the illustrated embodiment, source 110 has contact x 111 with connections to contacts a, b, c 112-114, source 120 has contact x 121 with connections to contacts a, b, d, e 122-125, source 130 has contact x 131 with connections to contacts a, b 132-133. Connections can sometimes be directed, so contact x may be connected to contact a who is not connected to contact x.

A contact is usually a person, but as identities are defined electronically by users, it is possible that a contact may be a group of more than one person. For example, a family may have a single entity as an email address, or a person may have more than one user identity.

Connections may be un-weighted and simply indicate a link between contacts, or connections may have relationship weights or strengths. For example, a relationship strength is defined as vₛᵢⱼ for source s, for the connection from contact i to contact j. It should be noted that relationship strengths can be directional, for example, vₛᵢⱼ does not have to be equal to vₛⱼᵢ. In the illustrated example in FIG. 1, the three sources 110-130 have connections with relationship strengths, whilst a social network 140 with un-weighted contacts is also shown.

Out of each source 110-130, a weighted list 151-153 of connected contacts is extracted for each contact. This can be done, for example, by creating a graph of relationships for all involved contacts or by keeping a separate list of relationships for each contact. Each source 110-130 defines the strength of relationships of connected contacts according to its own semantics.

For example, the source of co-authorship of papers could take into consideration the number of common papers of two contacts and how many contacts co-authored each paper with them. A blogging system could define the strength according to whether they commented on each others' blogs and how often. In general, the following factors among others can influence the weight computation for connections between contacts:
Number of common interactions.
Number of total interaction of each person.
Number of participants in each interaction.
Time span of interaction.
Time passed since interaction.
Symmetry of interaction.
Reciprocity of interaction.
Sentiment of interaction—whether it is a positive or negative interaction. A negative interaction (relationship) could make the weight lower.
Density of interaction—for example, the length of the time between interactions.
Age of the interaction—how long ago the interaction happened, the longer ago, the lower the weight.

A source's contacts' relationship strengths may be defined as vₛᵢⱼ for a relationship strength between contact i and contact j at source s. In the illustrated example:
source 110 has relationship strengths for contact x of: v₁ₓₐ, v_{1xb}, v_{1xc};
source 120 has relationship strengths for contact x of: v₂ₓₐ, v_{2xb}, v_{2xd}, v₂ₓₑ;
source 130 has relationship strengths for contact x of: v₃ₓₐ, v_{3xb}.

An aggregator 150 extracts the weighted lists 151-153 of relationship strengths of connections for a contact x from each source 110-130, as given above. The aggregator creates an aggregated weighted contacts list 154 in the form an aggregation of relationship strengths of connections for the contact x from multiple sources.

In one embodiment, the aggregated weighted contacts list 154 is created with each source Si being associated with a relative weight Wi, such that the sum of Wi=1. Suppose the values for the relationship between two contacts is Vi for Si. One way of aggregating the weights could be to compute the strength of the relationship between two contacts through the sum of Vi*Wi.

In the illustrated example, an aggregated relationship strength between contact x and contact a would be:

Vxa=(W1*v₁ₓₐ)+(W2*v₂ₓₐ)+(W3*v₃ₓₐ).

The Wi can be configured according to the extent to which the specific source expresses a relationship. One could for example say that the relationship as expressed in blog comments is less significant than the relationship as expressed by paper co-authorship. Thus the weight of the paper source would get a higher Wi value than that of the blogging source.

This assumes that each source return its weights in a normalized way, meaning that it describes the strength of a relationship relative to itself. So the strongest relationship should be 1 and the weakest 0. The configuration of the Wi can be user specific. A user can configure it according to the intensity of her activity in a certain source. So if a person is not blogging, it can set the Wi of blogging to 0, whereas if the person is writing a lot of papers, the Wi should be set to high relative to other sources.

The output of this process is the aggregated weighted contacts list 154 in the form of a weighted list of related contacts to a contact. The weight of a person p in the list of a person x, expresses the strength of the relationship between p and x. This list of weights of relationships can then be projected on the social network list of a non-weighted network. In FIG. 1, a non-weighted social network 140 is shown with connections between contacts x, a and d 141-143. The output relationship strength between contacts x and a determined by the aggregator 150 for sources 110-130 can be applied to the connection in the social network 140 to give the connection between the contacts a relationship strength.

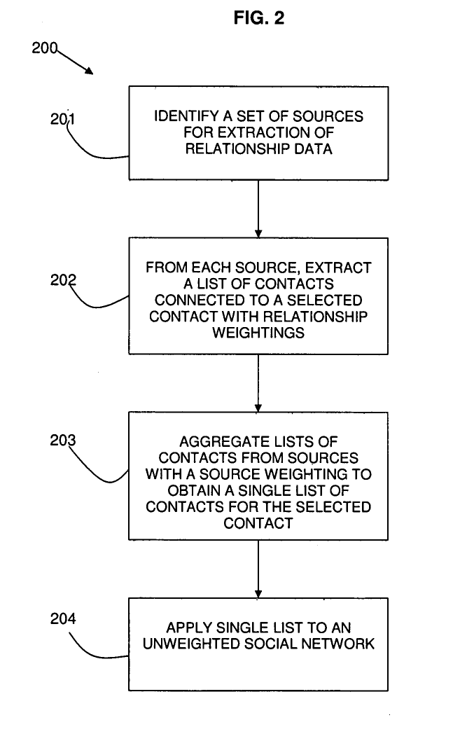

Referring to FIG. 2 a flow diagram shows the described method. First, a set of sources for the extraction of relationship data is identified 201.

From each source a list of contacts connected to a selected contact is extracted 202 with at least some of the connected contacts having relationship strengths. If a connection between contacts does not have a relationship strength, an average relationship strength may be used for the connection or a fixed weight, for example a weight of 1.

The lists of contacts connected to the selected contact, from the multiple sources are aggregated 203 with a source weighting applied to the results of a source to obtain a single list of contacts with aggregated relationships strengths.

The single list of contacts with aggregated relationship strengths for a given contact is applied 204 to an un-weighted social network in which the contacts appear.

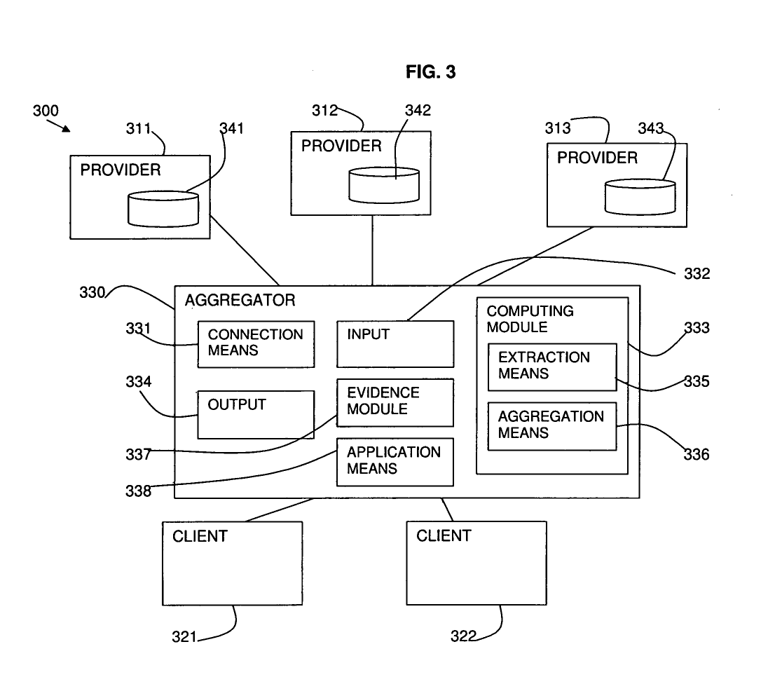

Referring to FIG. 3, a social network architecture 300 is shown in which a social network architecture application programming interface (API) is described for sharing social network data and aggregating it across applications to show who is related to whom and how.

Applications implementing the API referred to as social network providers 311-313 provide internal information about how strongly people are connected and by what means. Social network clients 321-322 can use the API to access data from a single provider 311-313 that implements the API. However, in the described architecture an intermediate component, an aggregator 330, is used by clients 321-322, with the API, to consolidate the data from different providers 311-313. This way, a client user can choose multiple providers 311-313 and assign an appropriate weight to each of them.

Clients 321-322 may take many different forms, for example, from expertise miners, through network visualizers, to user interface widgets. The described system answers questions such as “Who does this person communicate with most?”, “What are all the articles co-authored by these two individuals?”, “Whom should I invite to a brainstorm on a certain topic?”

Providers 311-313 include two types of data sources: personal (private) and public. Personal sources, such as email and instant messaging (IM), are only available to their owner and reflect the owner's personal, or egocentric, social network (i.e. all nodes in the network are directly related to the owner). Public data sources, such as blogs and organizational charts, are available to all users and reflect their extended, or sociocentric, network.

The described system maintains the privacy model of its data sources: only those users who have access to a certain piece of data by the original provider will have access to the social information extracted from this data by the API.

When used for creating a sociocentric view of a social network, the described system is based solely on public sources. Any user may use this view to examine publicly visible contacts within any group of people.

When used for creating an egocentric view of a user's network, the described system also makes use of the user's personal sources. Enriching the egocentric network, as reflected in personal sources, with information from public sources, opens up new opportunities for learning about one's extended network (i.e. one's connections and their connections with others). Consider, for example, Alice who seeks a social connection to Cindy. Cindy may not appear at all in Alice's egocentric network based on personal sources. However, examining the extended network, Alice may discover that Bob—who appears on her egocentric network by her personal data—is related to Cindy according to public sources. Alice will then be able to discover a social path to Cindy through Bob, based on aggregation of her personal and public sources.

The purpose of the described social network API is to provide open interfaces to social network data, “locked up” in a multitude of systems. The described system specifies a way to share weighted social networks as relation lists. Clients 321-322 may retrieve information about how people are connected based on different parameters. An embodiment of the described system provides a read-only interface, simple to implement by the provider 311-313 and consume by the client 321-322.

The first premise behind the described social network API is that it is necessary to present the strength of ties between people. In contrast to APIs for specific social network applications (for example, like Facebook), the described system does not model any specific semantics of the underlying system like “friending” or “communities”. Instead, it asks providers 311-313 to boil down these semantics into floating point numbers between 0 and 1.

An aggregator 330 combines results from multiple providers 311-313 using a simple weighted average. This approach enables diverse applications from instant messaging clients through publication databases to social network sites to provide data supporting an aggregated view of relationships among contacts. Clients 321-322 are oblivious to the types of relations—when querying for strength of a relationship, all that the client 321-322 sees is contacts and the weight of their associations.

Users of aggregated social network data frequently want to understand how people are connected, or why a connection is stronger than another. To support this need, the described system optionally allows queries for evidence. Evidence is essentially a time-ordered log 341-343 of entries, originating from each of the providers 311-313. It may include comments posted by one user in the other user's blog, email messages or chat transcripts between them, or web sites that they both bookmarked. According to the privacy model, users do not have access to any private material of other people through this interface—it just organizes information they already had access to before.

An embodiment of the described system is implemented as a REST (REpresentational State Transfer) API. The API has four methods. The first three are fetching weighted contact relationships, while the fourth provides evidence for connections. The methods are summarized in the table below.

| Name | Parameters | Output |
|---|---|---|
| Strength | source (user), target (user) | Float (0.0 to 1.0) |
| Relations | user(s), limit, offset | <list of people> |
| Network | user(s), degrees, threshold | <graph of people> |
| Evidence | user(s), limit, offset | <list of entries> |

The described system includes an aggregator 330 component that merges results from multiple providers 311-313. Like an HTTP proxy, the aggregator protocol is in most ways identical to the protocol for interacting with a provider 311-313. In fact, clients 321-322 communicate with aggregators 330 the exact same way they do with primary providers 311-313—through the API.

The aggregator 330 is configured with a connection means 331 to connect to one or more providers 311-313. When a request is received at an input 332, the aggregator 330 forwards it to each provider 311-313. It then processes the results by a computing module 333 which includes an extraction means 335 for extracting lists of contacts connected to a selected contact from sources and an aggregation means 336 which aggregates the lists of contacts from different sources computing a weighted average and returns the result to the user via an output 334. The original results from the different sources remain transparent to the user. An evidence module 337 records the connection basis from the time-ordered logs 341-343. An application means 338 is provided for applying the results of the computing module 333.

In one embodiment, providers 311-313 which serve as public sources may include: a blogging system, a tagging application, a friending application, a social bookmarking application, and an organizational chart.

For the blog system, social relations are derived from the comments made to one's blog. This information is an indication of the people who leave a trace in a blog, which is likely to imply that the author is aware of them and they are aware of the author. Friending is a reciprocal action: one person invites the other to be friends and they are defined friends only if the invitation is accepted. Tagging people is one sided, yet indicates some level of connection. Some applications support extraction of social information of both friending and tagging. In bookmark similarity information, the connections returned by the provider are those of people who bookmark the same pages. From the organizational chart, for each user, the user's manager as well as the user's direct peers—all employees who have the same manager can be extracted.

Several client-side providers 311-313 may be implemented that have access to the user's private data. Two of these are email and instant messaging transcripts. The outcome of these providers is only visible to the owner, visualizing an egocentric map of connections, but not revealing any private information to others.

For the email information, our client requests the user's password and then crawls the mailbox and collects details of people the user corresponds with.

In instant messaging, social information is extracted from the history of chat transcripts, as these indicate the people a person actually chats with.

In an internal organization application of the described system, contacts have organizational identifiers. The system can be applied outside an organization by using a system for mapping and sharing unique user IDs.

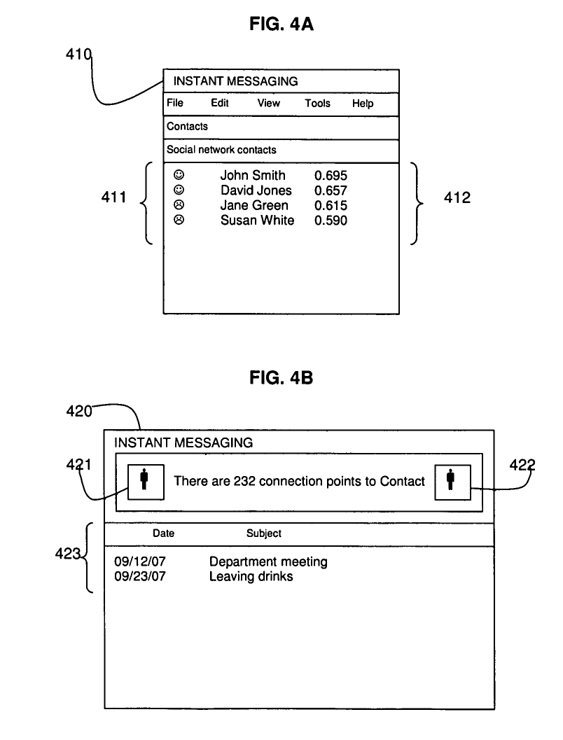

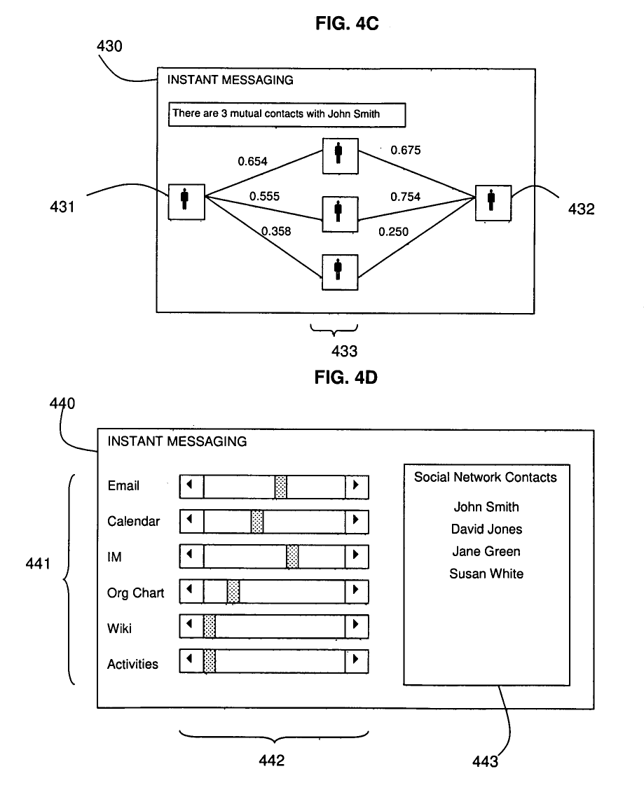

Referring to FIGS. 4A to 4D, one embodiment of usage of the API of the described system is in the form of a plugin for an instant messaging application with optional graphical user interfaces shown in FIGS. 4A to 4D 410, 420, 430, 440. The plugin presents an alternative contacts or buddy list as a graphical user interface 410, which consists of the people 411 most strongly related to the user, ordered by their strength of connection 412.

Additional features include the following. Showing related people to any buddy on the list. FIG. 4B shows a graphical user interface 420 with the connection points (evidence) between a user 421 and a buddy 422 in which a contact 422 is selected and the connection points 423 are listed. FIG. 4C shows a graphical user interface 430 with people who are connected to both the user 431 and a buddy 432 in which the mutual contacts 433 are illustrated.

The instant messaging extension has a preference page in which the user may choose the relative weight of each data source, the number of buddies to display, and the number of days in history to consider, etc. Referring to FIG. 4D, a graphical user interface 440 is shown for modifying the weight combination of different sources 441 which may be carried out with sliders 442. When adjusting the preferences, the user may see a preview 443 of the buddy list. This enables fine tuning the selection of weights.

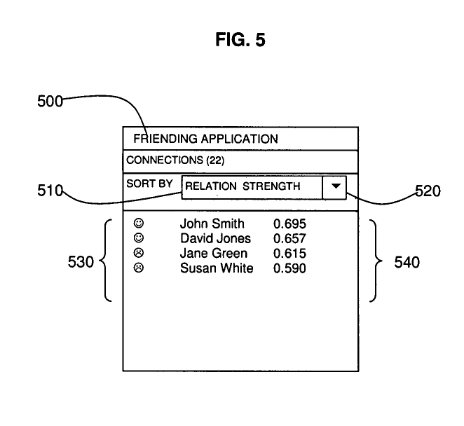

Referring to FIG. 5, an embodiment is shown of a friending application graphical user interface 500. The friending application is an un-weighted social network to which the aggregated relationship weightings of the described method can be applied. An option to sort by relationship strength 510 is provided in a drop-down menu 520. Contacts are listed 530 sorted by relationship strength 510 and may also include the relationship strength score 540.

Other example embodiments of the use of the API are as follows:

Scoring of non-weighted social networks. Social networks which do not use relationship strengths between contacts can be scored using aggregated relationship strengths from other weighted social networks.

Expertise location. The API integrated with search may be used for scenarios of expertise location, such as the basic “Who knows about <topic>?”, but also “Who do I know that knows about <topic>?”, and the related “Who do I mostly communicate with about <topic>?”. One of the parameters to the API is called query (could also be topic), which means to return the contacts related to the query. The system searches through the evidences to identify those that include the topic. This search can be source specific. The relationships that can be extracted from the evidences that fit the query are then returned.

Automatic completion of names and groups. Completing a single string to a name may sort alternatives by strength of social ties and relevance to the context. Moreover, the completion of a whole group can be supported. For example, if one participates in a project of 10 people, typing the names of 3 of them may automatically be completed to the entire group. This may also be useful for resolving “Who's missing from the mail I'm about to send?”.

Finding social paths. The information may be used to find social paths to someone who is not directly related to the user.

Enhancing social network services. Social network services may be enhanced by recommending people to connect to based on other evidence and by enriching information about existing friends: connection strength, evidence, and temporal characteristics of relationships.

A method of weighting relationships is described in the explicit social network of a person as expressed in social network services. The weighting of relationships is carried out by aggregating mined weighted social network data as can be extracted from different sources of implicit weighted data. Such sources of implicit weighted data include blog systems, wikis, forums, publications and patents repositories, email and instant messaging systems. Through associating weights with the relationships retrieved in each source and aggregating the weights into a consolidated weight, the overall strength of the relationship can be approximated. This can then be used to sort the un-weighted (or very partially weighted) lists of connections according to the strength of the relationship retrieved.

The described method and system enable aggregating weighted social networks from various sources into one aggregated weighted social network. In addition, it enables the weighting of social networks which are not weighted by themselves (e.g. like a friending service) to be weighted based on the weights extracted from other networks. Thus a friending application could, for example, sort your connections based on the weights retrieved from other networks and thus present to a user their strongest friends on top.

Enabling the association of a weight with each connection and thus sorting the connections by strength of a relationship, would enable viewing the strongest connections first, as these are normally those of most interest. It can also allow viewing of the weak ties first, which have been proven to be the most valuable in some scenarios. In addition, it would allow getting the x strongest/weakest ties for any x, in order to make some social network based filtering. For example, one can choose to get news only from his x strongest connection.

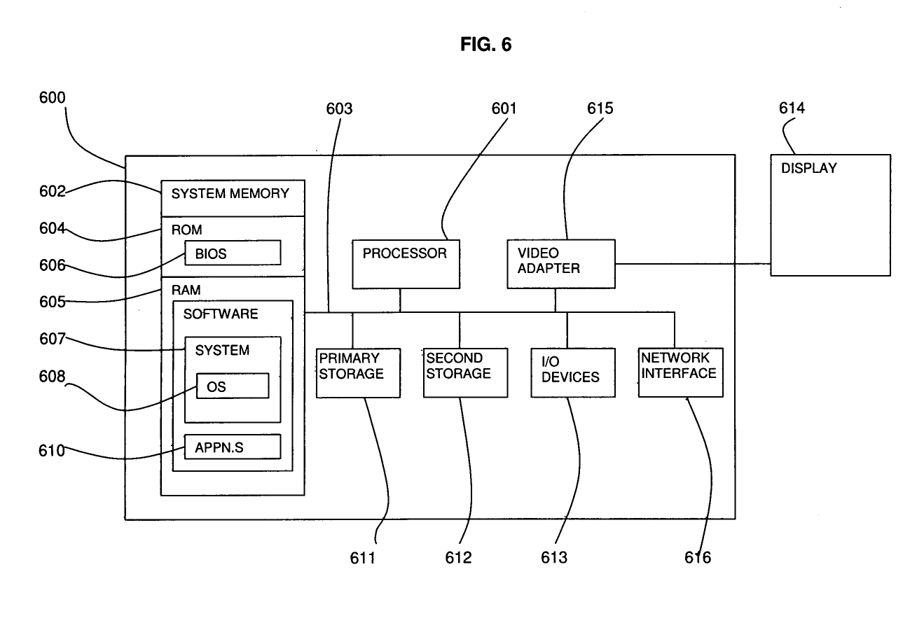

Referring to FIG. 6, an exemplary system for implementing aspects of the invention includes a data processing system 600 suitable for storing and/or executing program code including at least one processor 601 coupled directly or indirectly to memory elements through a bus system 603. The memory elements can include local memory employed during actual execution of the program code, bulk storage, and cache memories which provide temporary storage of at least some program code in order to reduce the number of times code must be retrieved from bulk storage during execution.

The memory elements may include system memory 602 in the form of read only memory (ROM) 604 and random access memory (RAM) 605. A basic input/output system (BIOS) 606 may be stored in ROM 604. System software 607 may be stored in RAM 605 including operating system software 608. Software applications 610 may also be stored in RAM 605.

The system 600 may also include a primary storage means 611 such as a magnetic hard disk drive and secondary storage means 612 such as a magnetic disc drive and an optical disc drive. The drives and their associated computer-readable media provide non-volatile storage of computer-executable instructions, data structures, program modules and other data for the system 600. Software applications may be stored on the primary and secondary storage means 611, 612 as well as the system memory 602.

The computing system 600 may operate in a networked environment using logical connections to one or more remote computers via a network adapter 616.

Input/output devices 613 can be coupled to the system either directly or through intervening I/O controllers. A user may enter commands and information into the system 600 through input devices such as a keyboard, pointing device, or other input devices (for example, microphone, joy stick, game pad, satellite dish, scanner, or the like). Output devices may include speakers, printers, etc. A display device 614 is also connected to system bus 603 via an interface, such as video adapter 615.

A social network weighting system may be provided as a service to a customer over a network.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

The invention can take the form of a computer program product accessible from a computer-usable or computer-readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read only memory (ROM), a rigid magnetic disk and an optical disk. Current examples of optical disks include compact disk read only memory (CD-ROM), compact disk read/write (CD-R/W), and DVD.

Improvements and modifications can be made to the foregoing without departing from the scope of the present invention.

We claim:

1. A method for relationship weighting in social networks, comprising:
identifying a plurality of sources of relationship data;
extracting from each source a list of connected contacts with a relationship strength for each connection;
aggregating the lists of contacts from the sources into an aggregated list, with each source having a source weighting; and
applying the aggregated list to a social network to provide relationship strengths between contacts.

2. A method as claimed in claim 1, wherein the list of connected contacts extracted from each source is a list of connected contacts to an identified contact and applying the aggregated list provides relationship strengths between contacts and the identified contact.

3. The method as claimed in claim 1, wherein each source defines relationship strengths for each connection according to relationship strength measures.

4. The method as claimed in claim 3, wherein the relationship strength measures include one or more of the group of: number of common interactions between contacts, number of total interactions of each contact, number of participant contacts in each interaction, time span of interaction, symmetry of interaction, reciprocity of interaction, sentiment of interaction, density of interaction, age of interaction.

5. The method as claimed in claim 1, wherein the source weightings are user configurable.

6. The method as claimed in claim 1, wherein applying the aggregated list to a social network applies the aggregated list to a social network with no previously defined relationship strengths.

7. The method as claimed in claim 1, wherein sources of relationship data include public sources of contact connections.

8. The method as claimed in claim 7, wherein the public sources of contact connections include one or more of the group including: web logs (blogs), wikis, friending applications, social tagging networks, social network services, publication or patent repositories, organizational charts, forums, file and photo sharing sites, web communities.

9. The method as claimed in claim 1, wherein sources of relationship data include private sources of contact connections and wherein access to the derived data is restricted to the owners of the private sources.

10. The method as claimed in claim 9, wherein the private sources of contact connections include one or more of the group including: email applications, instant messaging applications, calendar and scheduling applications.

11. The method as claimed in claim 1, including providing evidence of the derivation of contacts relationship strengths.

12. The method as claimed in claim 11, wherein the evidence is time-ordered log entries from the sources.

13. The method as claimed in claim 1, wherein applying the aggregated list to a social network to provide relationship strengths between contacts provides a contact list for an instant messaging system based on the relationship strength to the instant messaging application user.

14. The method as claimed in claim 13, including a preview of the contact list with different user selection of the source weightings.

15. The method as claimed in claim 1, including integrating the method with a topic search to locate contacts with expertise on the topic.

16. The method as claimed in claim 1, wherein applying the aggregated list to a social network to provide relationship strengths between contacts provides automatic completion of names.

17. The method as claimed in claim 1, wherein applying the aggregated list to a social network to provide relationship strengths between contacts provides social paths for indirectly related contacts.

18. The method as claimed in claim 1, wherein applying the aggregated list to a social network to provide relationship strengths between contacts provides enhanced social network services.

19. A computer software product for relationship weighting in social networks, the product comprising a computer-readable storage medium, storing a computer in which program comprising computer-executable instructions are stored, which instructions, when read executed by a computer, perform the following steps:
identifying a plurality of sources of relationship data;
extracting from each source a list of connected contacts with a relationship strength for each connection;
aggregating the lists of contacts from the sources into an aggregated list, with each source having a source weighting; and
applying the aggregated list to a social network to provide relationship strengths between contacts.

20. A method of providing a service to a customer over a network, the service comprising:
identifying a plurality of sources of relationship data;
extracting from each source a list of connected contacts with a relationship strength for each connection;
aggregating the lists of contacts from the sources into an aggregated list, with each source having a source weighting; and
applying the aggregated list to a social network to provide relationship strengths between contacts.

21. A system for relationship weighting in social networks, comprising:
a processor;
means for connection to a plurality of sources of relationship data;
means for extracting from each source a list of connected contacts with a relationship strength for each connection;
means for aggregating the lists of contacts from the sources into an aggregated list, with each source having a source weighting; and
means for applying the aggregated list to a social network to provide relationship strengths between contacts.

22. The system as claimed in claim 21, including means for input of user configurable source weightings.

23. The system as claimed in claim 21, wherein sources of relationship data include private sources of contact connections and the system includes means to restrict access to the derived data to the owners of the private sources.

24. The system as claimed in claim 21, including means for providing evidence of the derivation of contacts relationship strengths.
